(19) United States
(12) Patent Application Publication
(10) Pub. No.: US 2002/0169770 A1
(43) Pub. Date: Nov. 14, 2002

(54) Apparatus and method that categorize a collection of documents into a hierarchy of categories that are defined by the collection of documents

(76) Inventors: Brian Seong-Gon Kim, San Jose, CA (US); Sudong Chung, San Jose, CA (US); Daeho Baek, San Jose, CA (US)

Correspondence Address: PILLSBURY WINTHROP LLP, DOCKET/CALENDAR DEPARTMENT, 50 FREMONT STREET, SAN FRANCISCO, CA, 94105-2230, US

(21) Appl. No.: 09/844,040

(22) Filed: Apr. 27, 2001

(51) Int. Cl. G06F 7/00

(52) U.S. Cl. 707/5

(57) ABSTRACT

A collection of documents, such as the documents that result from a Web search, is categorized into a hierarchy of categories based on the documents in the collection. Various types of information, such as the title of a document, a document format type, and anchor text are utilized to determine the similarity between documents and generate most relevant and accurate categories.

### BACKGROUND OF THE INVENTION

1. Field of the Invention

The present invention relates to collections of documents and, more particularly, to an apparatus and method that categorize a collection of documents into a hierarchy of categories that are defined by the collection of documents.

2. Description of the Related Art

The World Wide Web (Web) is a rapidly growing part of the Internet. One group estimates that the Web grows roughly seven million Web pages each day, adding to an already enormous body of information. One study estimates that there are more than two billion publicly available Web pages. However, because of the Web's rapid growth and lack of a central organization, millions of people cannot find specific information in an efficient manner.

Two of the widely used tools for information retrieval on the Web are directories and search engines. Directories typically use a number of categories and, for each category, a number of subcategories. Web pages are then assigned to a particular category and subcategory depending on a specific classification approach.

For example, Yahoo! utilizes a hierarchy of categories, such as Computer & Internet and Education. A user chooses a category, then successive subcategories that seem likely to lead the user to the information sought. The quality of a Web directory depends on several factors, such as the quality of the categorization schema (Is it easy to understand? Does it cover all subjects?), accuracy (Is the assignment of a document to a category proper?), coverage (Does it have all relevant documents in a category?), and timeliness (How quickly it reflects the changes in the Web?).

To achieve high marks on first two factors, Web directories traditionally rely on specially trained human classifiers. This approach, however, requires too much skilled manpower. By late-1999, Yahoo! reported indexing more than 1.2 million Web pages, but this is relatively small compared to the Web. In late 1999, Yahoo! had about 100 editors compiling and categorizing Web sites.

However, even if this number of editors greatly increases, Yahoo! is not expected to be able to cover the entire Web. Moreover, manual categorization is too slow to keep a Web directory up to date with an ever-evolving Web. New documents are created, and old ones removed or changed. New categories emerge, and old ones fade away or take up new or additional meanings. Thus, one of the big disadvantages of Web directories is the narrow and dated coverage that is provided.

Web search engines are the other important means of information retrieval on the Web. The WISEnut search engine, for example, has substantial coverage of the Web, indexing over a half billion pages. However, as search engines increase their coverage, they exacerbate an existing problem, that being an overload of information.

Search engines pull up all Web pages meeting the search criteria, which can overwhelm a user with thousands of irrelevant pages. In addition, under-specified query terms—in some cases the user does not know exactly what information is desired and tends to submit very general and under specified queries—can produce thousands of additional irrelevant pages.

Once the Web pages are identified, the user must review them one Web page at a time to find the relevant ones. Even if the user could download many pages, average users are not always willing to take a look at more than a display of pages. Therefore it is important to present the search results in such a way that helps the user easily browse the search results.

There are two main approaches to presenting search results. The majority of the current-generation search engines present search results as a list of ranked documents where a fixed number of results, usually ten, is displayed at a time. A great deal of research has been done in search of better ranking methods to put more relevant results high on the list.

The ranking method used by the WISEnut search engine, for example, uses a context-sensitive link analysis. The results for most of the queries show dramatic improvement in terms of relevancy over conventional search engines. Even though this type of ranking system greatly helps the user to find the information they are looking for, in many cases the lists tend to be too long and require the user to sift through each item on the list.

Another approach to presenting search results is illustrated by the Northern Light search engine, which assigns the results of a keyword search into a number of predefined groups (or folders) with predefined headings. By using predefined groups, the documents obtained from the search are sorted into groups that generally have a similar subject, source, or type.

One problem with the Northern Light approach is that since these groups are predefined, the groups tend to contain many low relevance documents. (The predefined groups are compiled manually before the search, and the potential folders for each document are pre-computed during indexing. This tends to create many repeating folder names in different levels of the hierarchy.)

Thus, there is a need for a method of presenting the results of a keyword search on the Web that does not require manual categorization or compilation, and provides shorter and more relevant lists of documents for a user to review.

### SUMMARY OF THE INVENTION

The present invention provides a method for categorizing a collection of documents into a hierarchy of categories. As a result, a search engine can use the present invention to present the search results to keyword queries as a hierarchy of categories rather than a ranked list of documents. The present invention categorizes the ranked list of documents into a few, but typically not more than 20, categories.

The method of the present invention categorizes an initial collection of documents where each document is represented by a string of characters. The method of the present invention includes the step of identifying predefined characters in the string of characters from the documents in the initial collection of documents to form identified characters. The method also includes the step of changing the identified characters in the documents in the initial collection of documents to form a preprocessed collection of documents.

The method further includes the step of constructing a number of categories from the preprocessed collection of documents. The method additionally includes the step of assigning each document in the preprocessed collection of documents to one or more categories to form a number of categorized lists of documents.

The present invention also includes an apparatus that categorizes a collection of documents where each document is represented by a string of characters. The apparatus includes means for identifying predefined characters in the string of characters from each document to form identified characters, and means for changing the identified characters in each document to form a preprocessed collection of documents. The apparatus further includes means for constructing a number of categories from the preprocessed collection of documents, and means for assigning each document in the preprocessed collection of documents to one or more categories to construct a hierarchy of categories of documents.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block-diagram illustrating a computer 100 in accordance with the present invention.

FIG. 2 is a flow chart illustrating a method 200 for categorizing a collection of documents into a hierarchy of categories in accordance with the present invention.

FIG. 3 is a flow chart illustrating a method 300 of implementing step 212 in accordance with the present invention.

FIG. 4 is a flow chart illustrating a method 400 of implementing step 214 in accordance with the present invention.

FIG. 5 is a flow chart illustrating a method 500 for implementing step 414 in accordance with the present invention.

FIG. 6 is a flow chart illustrating a method 600 in accordance with an alternate embodiment of the present invention.

### DETAILED DESCRIPTION

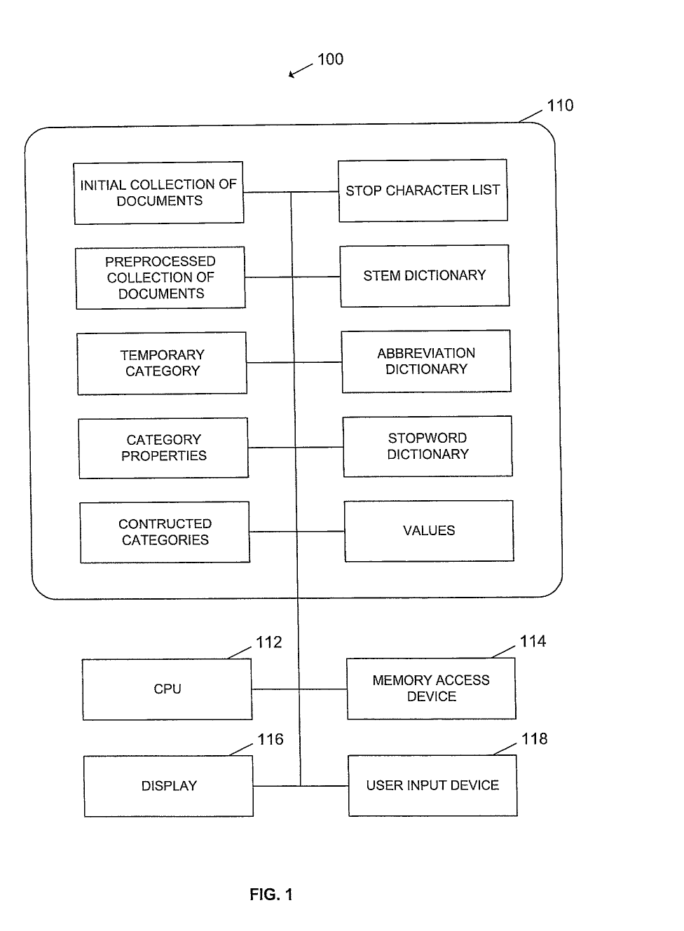

FIG. 1 shows a block-diagram that illustrates a computer 100 in accordance with the present invention. As described in greater detail below, the present invention utilizes the documents from a collection of documents to categorize the collection of documents into a hierarchy of categories. The collection of documents can be, for example, a collection of Web pages provided by a search engine in response to a specific query. (Other collections of documents can alternately be used.) As a result, a search engine can use the present invention to present the search results to keyword queries as a hierarchy of categories rather than a ranked list of documents.

As shown in FIG. 1, computer 100 includes a memory 110 that has an operating system block that stores an operating system, a program instruction block that stores program instructions, and a data block that stores data. The operating system can be implemented with, for example, the Microsoft 2000 Server operating system, although other operating systems such as Solaris or Linux can alternately be used. The program instructions can be written, for example, in C++although other languages can alternately be used.

The data block has segments to store an initial collection of documents with unique identification numbers, a preprocessed collection of documents with the same unique identification numbers, a temporary category as a candidate for a new category that contains the identification numbers of the documents, a number of variables representing the category properties of the temporary category under consideration, a number of values, a stop-character list, a stem dictionary, an abbreviation dictionary, a stop word dictionary, and a number of constructed categories of documents that contain the identification numbers of the member documents.

As further shown in FIG. 1, computer 100 also includes a central processing unit (CPU) 112 that is connected to memory 110. CPU 112, which can be implemented with, for example, a Pentium processor, categorizes the collection of documents in response to the program instructions and the data. Although only one processor is described, the present invention can be implemented with multiple processors in parallel to increase the capacity to process large amounts of documents.

Further, computer 100 includes a memory access device 114, such as a disk drive or a networking card, which is connected to memory 110 and CPU 112. Memory access device 114 allows the program instructions to be transferred to memory 110 from an external medium, such as a disk or a networked computer. In addition, device 114 allows the constructed categories of documents in memory 110 or CPU 112 to be transferred to the external medium.

Computer 100 further includes a display system 116 that is connected to CPU 112. Display system 116 displays images to the user, which are necessary for the user to interact with the program. Computer 100 also includes a user-input device 118, such as a keyboard and a pointing device, which is connected to CPU 112. The user operates input device 118 to interact with the program.

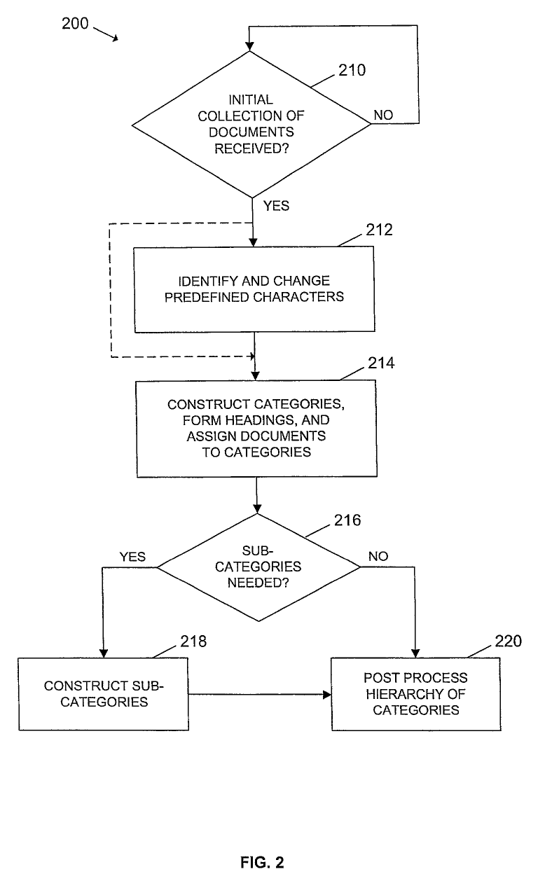

FIG. 2 shows a flow chart that illustrates a method 200 of categorizing a collection of documents into a hierarchy of categories in accordance with the present invention. Method 200 is implemented in software that is programmed into computer 100. As shown in FIG. 2, method 200 begins at step 210 by determining whether an initial collection of documents has been received. The initial collection of documents can be received from a number of sources, such as the output of a Web search. Method 200 also assigns a unique identification number for each document at step 210.

Each document in the initial collection of documents has a string of characters that represent the document. The string of characters, in turn, can include words, phrases, numbers, punctuation marks, abbreviations, and other symbols. Once an initial collection of documents has been received, method 200 optionally moves to step 212 where method 200 identifies predefined characters from the string of characters in the documents in the initial collection of documents, and changes the identified characters to form a preprocessed collection of documents. (If step 212 is not utilized, then method 200 moves to step 214.)

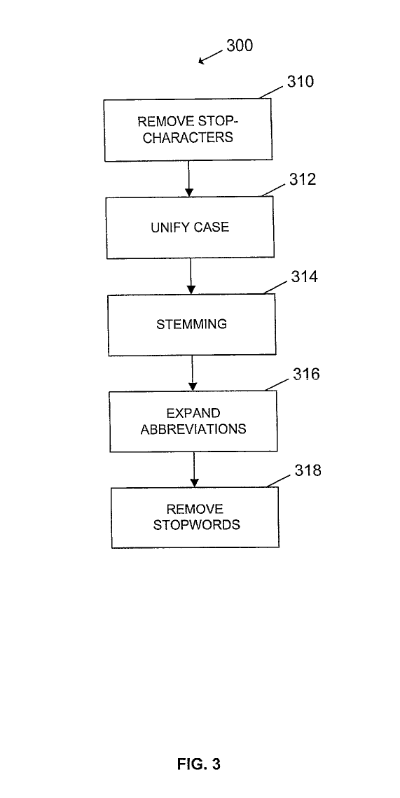

FIG. 3 shows a flow chart that illustrates a method 300 of implementing step 212 in accordance with the present invention. As shown in FIG. 3, method 300 begins at step 310 by removing stop characters from each of the documents in the initial collection of documents. For each document, method 300 compares each character in the string of characters that represent the document with the list of stop characters stored in memory 110, and removes a character from the string when the character matches a stop character in the list. The list of stop characters can include, for example, punctuation marks such as quotation marks and parentheses and, when multi-lingual documents are present, the characters written in a language code that is not supported by method 300.

Once the stop characters have been removed from each document in the initial collection of documents, method 300 moves to step 312 where upper-case characters in the documents are converted to lower-case characters. For each document, method 300 identifies the upper case characters in the string of characters that represent the document, and replaces the upper case characters with lower-case characters. (Upper case and lower case ASCII characters differ by a constant. Thus, when an upper case character is detected, subtracting the constant from the ASCII value of the upper case character can form the lower case character.) For example, the string “WISEnut” would be converted to “wisenut.”

After this, method 300 moves to step 314 where non-root words in the documents are converted to root words. For each document, method 300 looks up each word in the character string in the stem dictionary stored in memory 110 to determine the root of the word. If the looked-up word is not a root word, the word in the character string is replaced with its root word. For example, each word in a plural form can be converted to a word in a singular form, and all verbs can be converted to their root form. In this case, method 300 in step 314 would convert the character string “students went home” to its root form “student go home.”

Method 300 next moves to step 316 where abbreviations in the documents are converted into the original form of the word. For each document, method 300 looks up each abbreviation in the character string in the abbreviation dictionary stored in memory 110, and replaces the word with the original (expanded) form of the abbreviation when a match is found. The abbreviation dictionary includes a list of frequently used abbreviations and their original forms. For example, “dept. of physics” is expanded to “department of physics.”

Following this, method 300 moves to step 318 where stop words in the documents are removed. For each document, method 300 looks up each word in the character string in the stop-word dictionary stored in memory 110, and then removes the word from the character string if the word is in the stop-word dictionary.

The stop-word dictionary can include, for example, definite and indefinite articles. For example, the stop word dictionary may include “the” so that the character string “the white house” is replaced with the character string “white house”. When all of the documents have been preprocessed in step 318, the initial collection of documents has been converted into a preprocessed collection of documents that is stored in memory 110. Method 200 assigns to each document in the preprocessed collection of documents the same identification number as its original document in the initial collection of documents. Step 212 is then complete.

Returning to FIG. 2, once method 200 has identified and changed predefined characters in the documents in the initial collection of documents, method 200 moves to step 214 where method 200 constructs a number of categories from the preprocessed collection of documents. Method 200 also forms headings for each of the categories, and assigns each of the documents from the preprocessed collection of documents to one or more of the categories based on similar characteristics that are shared by the documents.

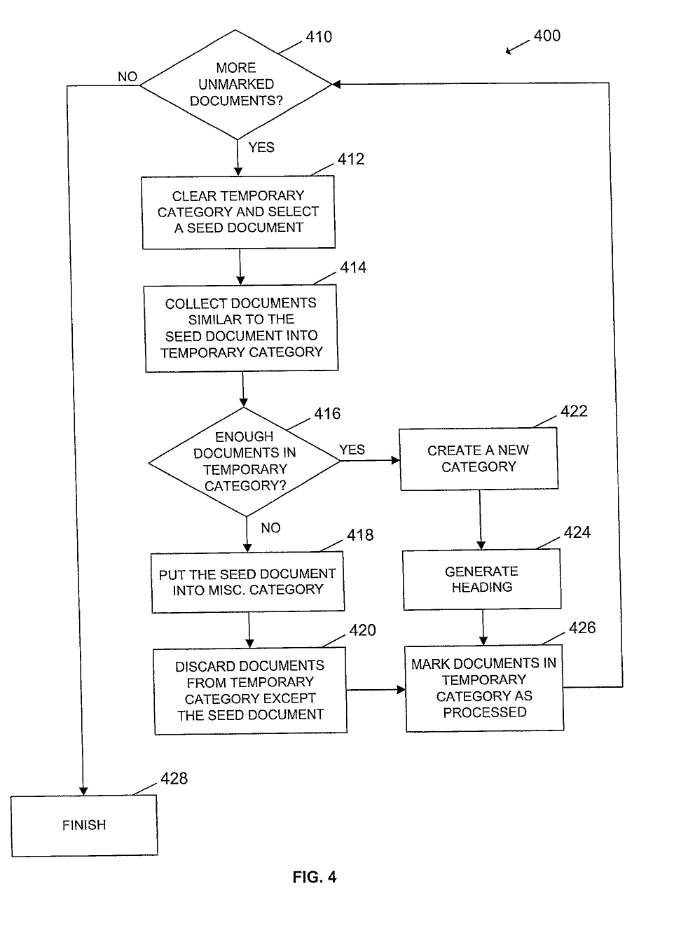

FIG. 4 shows a flow chart that illustrates a method 400 of implementing step 214 in accordance with the present invention. Method 400 utilizes the initial collection of documents when step 212 is skipped, and the preprocessed collection of documents when step 212 is included. The documents in both collections are unmarked initially, and then marked as processed when included within one or more categories. As shown in FIG. 4, method 400 begins at step 410 by determining whether there are documents not marked as processed in the initial or preprocessed collection of documents. When there are more documents not marked as processed, method 400 moves to step 412 to clear the temporary category and select a seed document for the temporary category.

The seed document can be selected in a number of ways. For example, in one embodiment, the first document in the initial or preprocessed collection of documents can be selected as the seed document. In another embodiment, the highest ranked document can be selected as the seed document if the rank values are available.

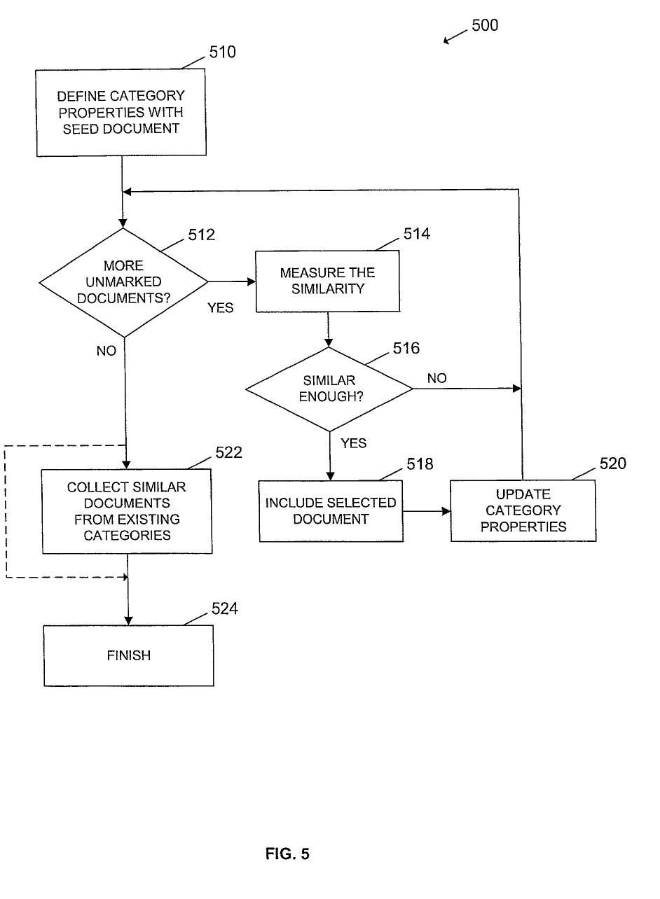

Once the seed document has been chosen, method 400 moves to step 414 where method 400 collects the identification numbers of all of the documents from the initial or preprocessed collection of documents that are similar to the seed document into the temporary category. FIG. 5 shows a flow chart that illustrates a method 500 for implementing step 414 in accordance with the present invention.

As shown in FIG. 5, method 500 begins at step 510 by utilizing the seed document to define the initial values of a number of category properties of the temporary category. The category properties represent the common properties of all member documents in the temporary category. For example, the category properties can have a common title property that represents the longest sub- string commonly appearing in the titles of all member documents. The values of category properties are stored in memory 110 and are updated each time the identification number of a new member document is added into the temporary category. The category properties can include, for example, the longest common sub-string in the title, the longest common sub-string in the body, and document type indices. The document type indices can be measured in terms of fractional numbers. The indices in the category properties, for example, can be represented as the list of <type, index>pairs, such as {<news article, 0.8>, <technical document, 0.6>, <poem, 0.1>, . . . }.

Thus, in one embodiment, the title of the seed document is loaded into memory 110 as the initial value of the longest common sub-string in the title category property. In another embodiment, the body of the seed document is loaded into memory 110 as the initial value of the longest common sub-string in the body category property.

Method 500 then moves to step 512 to determine if there are unmarked documents in the initial or preprocessed collection of documents that have not been measured against the present category properties. When documents remain to be measured, method 500 moves to step 514 to select the next document from the initial or preprocessed collection of documents and measure the similarity between the selected document and the current values of category properties.

For example, in one embodiment, the similarity measure can include the number of words in the longest common sub-string of the title. In this case, method 500 finds the longest sub-string that is common to the title of the selected document and the common title maintained in the category properties. In another embodiment, the similarity measure can include the number of words in the longest sub-string that is common to the body of the selected document and the common body maintained in the category properties.

Following this, method 500 moves to step 516 where method 500 tests to determine if the similarity measures between selected document and category properties exceed predetermined values. For example, with one category property, if the number of words in the longest common sub-string in the title is more than three, and the corresponding predetermined value is equal to three, then the selected document passes the similarity test. On the other hand, if the number of words in the longest common sub-string in the title is equal to two, then the selected document fails the similarity test.

A predetermined value, in turn, defines a measure of similarity. A high-predetermined value requires, for example, a longer common sub-string in the title and therefore means that only very similar documents will fall into the same category. On the other hand, a low-predetermined value allows a shorter common sub-string in the title and therefore means that less similar documents will fall into the same category.

When method 500 determines that the selected document passes the similarity test, method 500 moves to step 518 where method 500 includes the selected document in the temporary category by appending its identification number. When a new document is added in the temporary category, method 500 moves to step 520 and updates the values of the category properties of the temporary category to reflect the change. When document type indices are used, method 500 can update the document type indices by taking the average of the document type indices of all documents in the group.

On the other hand, when method 500 determines that the selected document fails the similarity test, method 500 rejects the selected document. After this, method 500 moves to step 512 to repeat the process until all documents not marked as processed in the initial or preprocessed collection of documents have been considered to determine whether the document is to be assigned to the temporary category. When all documents not marked as processed have been processed, method 500 optionally moves to step 522 to collect more similar documents from existing categories allowing some documents to belong to more than one category. (If step 522 is not utilized, then method 500 moves to step 524 to finish.)

Step 522 will loop over the existing categories and measure the similarity of each document in the existing categories and the category properties by employing the same methods used in steps 514, 516 and 518. Step 522, however, does not update the category properties when more documents are added to the temporary category. Method 500 then moves to step 524 to finish.

Returning again to FIG. 4, once the identification numbers of all of the documents that are similar to the seed document have been included in the temporary category, method 400 moves to step 416. In step 416, method 400 determines whether the number of documents in the temporary category (represented by the identification numbers) is enough to merit the creation of a category. To determine if a category should be created, method 400 accumulates the weight of each document to get the total weight of the collected documents in the temporary category.

For example, in one embodiment, each document contributes an equal weight of one. In another embodiment, a different weight is given to each document based on its rank value. The rank-weight pairs, for example, can be chosen as {<1, 2.0>, <2, 1.5>, <3,1.0>, <4, 1.0>, <5, 1.0>, . . . }. Method 400 considers the group to have a large enough number of documents to merit a new category if the total weight is more than a preset value, typically three.

When the number of documents is insufficient to warrant the creation of a category, method 400 moves to step 418 where method 400 assigns the seed document to a miscellaneous category. (Method 400 can construct the miscellaneous category if the seed document is the first document not to construct a new category. The miscellaneous category can alternately be predefined.)

The miscellaneous category is reserved for the documents that do not belong to any specific category. Method 400 then moves to step 420 to discard the identification numbers of all selected documents from the temporary category except the seed document. Method 400 then moves to step 426 to mark the seed document in the temporary category as processed. Method 400 then returns to step 410.

When the number of documents is sufficient to merit the construction of a category, method 400 moves to step 422 to create a new category for the documents in the temporary category and stores the list of identification numbers of the documents in memory 110 as a first constructed category. Method 400 then moves to step 424 to generate a heading to represent the newly created category. For example, in one embodiment, method 400 selects the longest common sub-string present in all of the titles of the member documents of the category as the heading. In another embodiment, method 400 can choose several, typically three, of the most common strings as the heading.

Method 400 then moves to step 426 to mark the documents in the temporary category as processed. Following this, method 400 returns to step 410 and repeats the process until all documents in the initial or preprocessed collection of documents have been marked as processed.

Thus, in step 412, the content of the temporary category is discarded and a new seed document is selected. In step 414, the identification numbers of the documents that are similar to the new seed document are collected into the temporary category, and in step 416 a determination is made as to whether the new seed document is to be added to the miscellaneous category in step 418 or whether a new category is to be formed in step 422. Once all of the documents in the initial or preprocessed collection of documents have been assigned to at least one of the categories and marked as processed, method 400 moves to step 428 to finish.

Returning to FIG. 2, once method 200 has constructed a number of categories and assigned each of the documents to one or more of the categories, method 200 moves to step 216 to determine if any category needs to be further processed to have sub-categories. When method 200 finds a category that has more than a preset number of documents, typically ten, method 200 moves to step 218 to form a number of sub-categories. The sub-categories are formed in the same way that the categories are formed in step 214 except that the process begins with a narrower collection of documents.

When the sub-categories have been defined, or if no sub-categories are to be defined, method 200 moves to step 220 where the resultant hierarchy of categories is post processed. The primary function of the post-processing is to merge any two categories that have too much overlap in their headings. Method 200 also performs other miscellaneous processing in step 220. For example, in one embodiment, method 200 can promote sub-categories to an upper lever in the hierarchy when the number of categories in the upper level is less than a preset value, typically two.

In one embodiment, a Web search engine can take the output list of categories and the documents contained in them and present the search results to a specific query. In another embodiment, an intranet search engine can use the output list of categories and the documents to organize the list of documents into a hierarchy of categories to facilitate the browsing of their database.

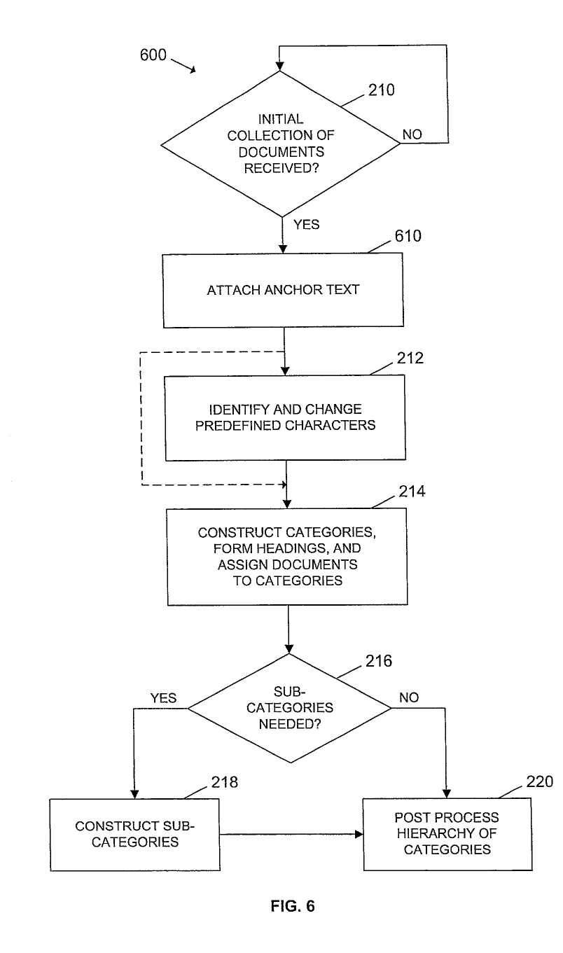

FIG. 6 shows a flow chart that illustrates a method 600 in accordance with an alternate embodiment of the present invention. Method 600 is similar to method 200 and, as a result, utilizes the same reference numerals to designate the steps that are in common to both methods. As shown in FIG. 6, method 600 differs from method 200 in that method 600 includes step 610 where method 600 includes the results of a context-sensitive link analysis.

A context-sensitive link analysis examines the inbound links to a Web page to help determine the relevancy of the page to a given category. When the author of an originating page makes a link to a destination page, the author of the originating page gives a brief description of the destination page. The brief description, known as anchor text, tends to give a more objective view of the content and quality of the destination page because many of the inbound links to the destination page originate from authors other than the one who wrote the destination page.

In the present invention, the anchor text associated with each inbound link (hyperlink) to each Web page is stored in a database. The database can be arranged to have an entry for each hyperlink where each entry contains three columns (fields) for the source URL (the internet address), the destination URL, and the anchor text of the inbound link. For example, if three Web pages provide links to the XYZ Web page, then the database would contain three entries for the XYZ Web page that store the anchor texts of the three inbound links.

In addition to including the anchor text, the database also stores data that provides a ranking of each anchor text relative to the other anchor texts with same destination URL. Continuing with the above example, one of the three anchor texts would be identified as being the highest-ranked anchor text, one as the lowest-ranked anchor text, and one as the middle-ranked anchor text.

The anchor texts can be ranked in a number of ways. For example, in one embodiment, the anchor texts are ranked in terms of the frequency of use of the inbound link. In another embodiment, the anchor texts are ranked using the partial extrinsic rank as described in U.S. patent application Ser. No. 09/757,435, “Systems and Methods of Retrieving Relevant Information” filed by Kim, et al. to select the representative anchor text. The partial extrinsic rank, PER(UA; a), for document a and anchor text UA is defined as:

$$PER ( UA ; a ) = {\sum }_{c} AW ( UA ; c \to a ) \cdot PW ( c )$$

Here document c represents all documents that contain a link to document a with the identical anchor text, UA. AW(UA;c→a) denotes the anchor weight that represents the weight given to anchor text found in document b linking to document a for a given anchor text UA. PW(c) represents the page weight for document c. Page weight of a document represents the relative importance of the document.

Returning to FIG. 6, method 600 determines if an initial collection of documents has been received at step 210 in the same manner as method 200. Method 600 then moves to step 610. As noted above, each document in the initial collection of documents has a string of characters that represents the document. In step 610, for each document in the initial collection of documents, method 600 outputs the URL of the document to the database.

In response, method 600 receives a character string that represents the highest ranked anchor text (although anchor texts with other rankings can alternately be used) that has the requested URL as the destination URL from the database. (The highest-ranked anchor text can be the most frequently used anchor text when this ranking is available. The highest-ranked anchor text can alternately be the text with the highest partial extrinsic rank value when the partial extrinsic rank for each unique anchor text variation is available.)

Method 600 then attaches the character string that represents the anchor text to the string of characters that represents the document. Thus, when step 610 is finished, the string of characters that represents each document includes the original string and the anchor text string.

Following this, method 600 moves to step 212, and method 600 continues in the same manner as method 200. The advantage of attaching anchor text to the character strings of the documents is that the anchor text can be used to define the category properties. Since the anchor text provides an objective synopsis of the Web page, the anchor text can define improved category properties.

Thus, an apparatus and a method for categorizing a collection of documents, such as the collection that results from a search on the Web, as a number of categorized lists have been described. The apparatus and method of the present invention work on the collection of documents identified in a Web search and thus, if the search engine has a large number of indexed pages, provides the most up to date search results that are possible.

In addition, the apparatus and method of the present invention generate category names that are derived from the documents in the collection. Thus, unlike predefined category names, the category names of the present invention are customized for each search, thereby providing a more accurate categorization of the documents.

As a result, the present invention combines the advantages of Web directories that have categorized lists, and Web search engines that provide a larger number of more relevant and timely documents. This real-time customization of the categories and category names enables the present invention to provide highly relevant categories specifically tailored for given search result.

The present invention presents search results that are presented in a manageable number of categories according to the topics instead of a linear list of ranked documents. The user can quickly scan over the list of categories and decide which one to pursue further. Unlike other existing Web directories, the categorization in the present invention is done by an automated process and is not maintained manually. The automatic categorization of documents allows a user to cover as many pages as the search engine covers the Web, thereby enabling a user to keep abreast with the ever-evolving Web.

It should be understood that various alternatives to the embodiment of the invention described herein might be employed in practicing the invention. Thus, it is intended that the following claims define the scope of the invention and that methods and structures within the scope of these claims and their equivalents be covered thereby.

What is claimed is:

1. A method of categorizing an initial collection of documents, each document being represented by a string of characters, the method comprising the steps of:
identifying predefined characters in the string of characters from the documents in the initial collection of documents to form identified characters;
changing the identified characters in the documents in the initial collection of documents to form a preprocessed collection of documents;
constructing a number of categories from the preprocessed collection of documents; and
assigning each document in the preprocessed collection of documents to a category to form a hierarchy of categories of documents.

2. The method of claim 1 wherein the step of constructing a number of categories includes the steps of:
clearing a temporary category and selecting a seed document as a first document of the temporary category;
collecting documents from the preprocessed collection of documents that are similar to the seed document into the temporary category;
testing to determine if there are enough documents in the temporary category to merit construction of a new category;
constructing the new category and generating a heading for the new category if there are enough documents in the temporary category to merit construction;
assigning the seed document to a category reserved for documents not belonging to any specific category if there are not enough documents in the temporary category; and
marking the documents assigned to any category in the preprocessed collection of documents as processed.

3. The method of claim 2 wherein the predefined characters include punctuation marks, and the changing step removes the punctuation marks from the string of characters.

4. The method of claim 2 wherein the predefined characters include upper-case characters, and the changing step replaces upper-case characters with lower-case characters.

5. The method of claim 2 wherein the predefined characters include non-root words, and the changing step replaces the non-root words with root words.

6. The method of claim 2 wherein the predefined characters include abbreviations, and the changing step replaces the abbreviations with original words.

7. The method of claim 2 wherein the predefined characters include articles, and the changing step removes the articles from the string of characters.

8. The method of claim 2 wherein the collecting step further includes the step of loading a character string from the seed document into a memory location to initialize the values of a number of category properties for the temporary category.

9. The method of claim 8 and further comprising the steps of:
determining if there are documents in the preprocessed collection of documents that have not been processed with respect to the temporary category;
if there are documents in the preprocessed collection of documents that have not been processed with respect to the temporary category, selecting a next document from the preprocessed collection of documents and measuring a similarity with a similarity test between the selected document and a number of current category properties;
including the selected document in the temporary category if the selected document passes the similarity test;
updating the values of the number of category properties of the temporary category when the selected document is included; and
rejecting the selected document if the selected document fails the similarity test.

10. The method of claim 9 and further comprising the step of repeating the steps of claim 9 for all documents in preprocessed collection of documents.

11. The method of claim 2 wherein the collecting step further includes the step of collecting more similar documents from a number of existing categories.

12. The method of claim 11 and further comprising the steps of:
determining if there are more documents in a number of existing categories that have not been processed with respect to the temporary category;
if there are documents in the number of existing categories that have not been processed with respect to the temporary category, selecting a next document from the number of existing categories as a selected document and measuring a similarity with a similarity test between the selected document and a number of current category properties;
including the selected document in the temporary category if the selected document passes the similarity test; and
rejecting the selected document if the selected document fails the similarity test.

13. The method of claim 12 and further comprising the step of repeating the steps of claim 12 for all documents in the number of existing categories.

14. The method of claim 8 wherein the category properties includes a string of characters selected from the group consisting of a longest common sub-string in the title, a longest common substring in the body; and a document type index measured as list of fractional numbers for each document type.

15. The method of claim 14 wherein a document type includes types selected from the group consisting of news article, technical documents, and poems.

16. The method of claim 2 and further comprising the steps of:
making sub-categories if there are too many documents in a given category; and
post-processing the number of categorized lists of documents.

17. The method of claim 16 wherein the categorized list of documents is post-preprocessed by the following steps:
merging two categories that each have a heading where there is too much overlap in the headings of the two categories; and
promoting sub-categories to an upper level in a hierarchy when there are not enough categories in the upper level.

18. The method of claim 2 wherein the seed document is a first document in the preprocessed collection of documents.

19. The method of claim 2 wherein the seed document is a document with a highest rank value among the documents not marked as processed in the preprocessed collection of documents.

20. The method of claim 2 wherein the temporary category is tested to determine if there are enough documents in the temporary category to merit construction of a new category by accumulating the weight of each document when each document can contribute uniform weight or different weight based on the rank value of each document with higher ranked document given more weight.

21. The method of claim 2 wherein the heading is a longest common substring in a title.

22. The method of claim 21 wherein the heading includes a number of longest common substrings.

23. The method of claim 1 and further comprising the steps of:
determining if an anchor-text character string is available for the documents in the initial collection of documents; and
attaching an anchor-text character string to the string of characters that represents the documents in the initial collection of documents when the anchor-text character string is available.

24. The method of claim 23 wherein the anchor-text character string is a text used most frequently by hypertext documents.

25. The method of claim 23 wherein the anchor-text character string is a text with a highest partial extrinsic rank value.

26. A method of categorizing an initial collection of documents, each document being represented by a string of characters, the method comprising the steps of:
constructing a number of categories from the initial collection of documents wherein a category is constructed by:
clearing a temporary category and selecting a seed document as a first document of a temporary category;
collecting documents from the initial collection of documents to the temporary category that are similar to the seed document;
testing to determine if there are enough documents in the temporary category to merit construction of a new category;
constructing the new category and generating a heading for the new category if there are enough documents in the temporary category to merit construction;
assigning the seed document to a category reserved for documents not belonging to any specific category if there are not enough documents in the temporary category; and
marking the documents assigned to any category in the initial collection of documents as processed; and
assigning each document in the initial collection of documents to a category to form a hierarchy of categories of documents.

27. The method of claim 26 wherein the collecting step further includes the step of loading a character string from the seed document into a memory location to initialize values of a number of category properties for the temporary category.

28. The method of claim 27 and further comprising the steps of:
determining if there are documents in the initial collection of documents that have not been marked as processed;
if there are documents in the initial collection of documents that have not been marked as processed, selecting a next document from the initial collection of documents and measuring a similarity with a similarity test between the selected document and a number of current category properties;
including the selected document in the temporary category if the selected document passes the similarity test; and
rejecting the selected document if the selected document fails the similarity test.

29. The method of claim 28 and further comprising the step of repeating the steps of claim 28 for all documents in initial collection of documents.

30. The method of claim 26 wherein the collecting step further includes the step of collecting more similar documents from a number of existing categories.

31. The method of claim 30 and further comprising the steps of:
determining if there are more documents in the number of existing categories that have not been processed with respect to the temporary category;
if there are documents in the number of existing categories that have not been processed with respect to the temporary category, selecting a next document from the number of existing categories and measuring a similarity with a similarity test between the selected document and a number of current category properties;
including the selected document in the temporary category if the selected document passes the similarity test; and
rejecting the selected document if the selected document fails the similarity test.

32. The method of claim 31 and further comprising the step of repeating the steps of claim 31 for all documents in number of existing categories.

33. The method of claim 1 wherein each document in the preprocessed collection of documents is assigned to one or more categories to form a hierarchy of categories.

34. The method of claim 26 wherein each document in the initial collection of documents is assigned to one or more categories to form a hierarchy of categories.

35. The method of claim 2 and further comprising the step of repeating the steps of claim 2 until all documents in the preprocessed collection of documents are marked as assigned to a category.

36. The method of claim 35 wherein the documents in the preprocessed collection of documents are initialized as unmarked before selecting a first seed document.

37. The method of claim 26 and further comprising the step of repeating the constructing steps of claim 26 until all documents in the initial collection of documents are marked as assigned to a category.

38. The method of claim 37 wherein the documents in the preprocessed collection of documents are initialized as unmarked before selecting a first seed document.

39. An apparatus that categorizes a collection of documents, each document being represented by a string of characters, the apparatus comprising:
means for identifying predefined characters in the string of characters from each document to form identified characters;
means for changing the identified characters in each document to form a preprocessed collection of documents;
means for constructing a number of categories from the preprocessed collection of documents; and
means for assigning each document in the preprocessed collection of documents to a category to form a number of categorized lists of documents.
